(19) United States
(12) Patent Application Publication
(10) Pub. No.: US 2010/0103323 A1
(43) Pub. Date: Apr. 29, 2010

(54) METHOD, APPARATUS AND SOFTWARE FOR DETERMINING MOTION VECTORS

(75) Inventor: Gordon Finn Wredenhagen, Toronto (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 12/258,084

(22) Filed: Oct. 24, 2008

(51) Int. Cl. H04N 5/14

(52) U.S. Cl. 348/699; 348/E05.062

(57) ABSTRACT

Motion vectors are determined from two images by obtaining one or more candidate motion vectors from the two images. Regions of the two images associated with the candidate motion vector are modified. Thereafter, further candidate motion vectors are obtained from the modified images, reducing the interfering effect of regions for which motion vectors have already been determined.

### FIELD OF THE INVENTION

The present invention relates generally to image processing, and more particularly to methods and apparatus for determining motion vectors for image sequences.

### BACKGROUND

In image processing, a motion vector is a vector that represents the direction and magnitude of the displacement of an object from one image to another. For example, a motion vector may represent the apparent motion of an object between two sequential image frames in a video sequence. Motion vectors are used, for example, in video compression and video frame rate conversion.

One conventional technique for determining motion vectors searches two images for matching regions, and uses the relative displacement between matching regions to define the motion vectors for the two images. Typically, the second image is segmented into regions of one or more pixels. For every segmented region in the second image, the first image is searched for the region that best matches the segmented region under consideration.

An alternative technique is to determine a correlation surface for the two images, or portions of an image. A correlation surface represents the correlation of two images if the two images are displaced relative to each other in all directions and magnitudes. Typically, the points corresponding to the peaks of the correlation surface may be used to determine candidate motion vectors. However, candidate motion vectors do not necessarily correspond to actual motion of objects between the two images. Further calculation is required to determine motion vectors that best correspond to the actual motion of objects from the candidate motion vectors.

Thus, there is a need for methods and apparatus for determining motion vectors that can overcome one or more problems mentioned above.

### SUMMARY OF THE INVENTION

In accordance with an aspect of the present invention, there is provided a method of determining motion vectors for images, comprising: (a) determining a first region in a first image and a second region in a second image associated with a candidate motion vector; (b) modifying the first and second images by setting pixel intensities in the first and second regions in the first and second images to a default intensity; and (c) obtaining and storing a candidate motion vector from the first and second images as modified in (b), as a motion vector for the first and second images.

In accordance with another aspect of the present invention, there is provided a method of determining motion vectors for first and second images. The method comprises: (a) obtaining at least one candidate motion vector representing motion of a region from the first image to the second image; (b) determining the region in the first image and the second image associated with the at least one candidate motion vector; (c) modifying the first and second images by setting pixel intensities in the region in the first and second images to a default intensity; and (d) repeating the obtaining, determining, and modifying, using the first and second images as modified in (c), until a desired number of motion vectors have been determined for the first and second images.

In accordance with yet another aspect of the present invention, there is provided a video processor comprising: a first logic block for obtaining at least one candidate motion vector representing motion of a region from the first image to the second image; a second logic block for determining the region in the first image and the second image associated with the at least one candidate motion vector; a third logic block for modifying the first and second images by setting pixel intensities in the region in the first and second images to a default intensity; and wherein the first, second and third logic blocks repeat the obtaining, determining, and modifying, using the first and second images as modified by the third logic block, until a desired number of motion vectors have been determined for the first and second images.

### BRIEF DESCRIPTION OF THE DRAWINGS

In the figures, which illustrate, by way of example only, embodiments of the present invention;

FIG. 1 is a schematic block diagram of a computing device, exemplary of an embodiment of the present invention;

FIG. 2 is a schematic diagram showing a sequence of images;

FIG. 3 is a schematic diagram of the first image frame in FIG. 2, showing the individual pixels of a portion of the first frame in a coordinate system;

FIG. 4 is a schematic diagram of the first image frame in FIG. 2, showing the intensity values of individual pixels of a portion of the first frame;

FIG. 5 is a superposition of the first and second image frames of FIG. 2 with their outer edges co-registered;

FIG. 6 is a flowchart of a method of motion vector determination;

FIG. 7 shows a modified version of the first image frame in FIG. 2;

FIG. 8 shows a modified version of the second image frame in FIG. 2;

FIG. 9 is a flowchart for a method of obtaining candidate motion vectors;

FIG. 10 is a correlation surface of the first and second image frames of FIG. 2;

FIG. 11 shows the first image frame of FIG. 2 displaced relative to the second image frame of FIG. 2;

FIG. 12 is a flowchart for a method of motion vector determination;

FIG. 13 shows a twice modified version of the first image frame in FIG. 2;

FIG. 14 shows a twice modified version of the second image frame in FIG. 2;

FIG. 15 is a flowchart for a method of motion vector determination;

FIG. 16 is a flowchart for a method of determining first and second regions in the first and second image frames in FIG. 2 associated with candidate motion vectors;

FIG. 17 shows the first image frame of FIG. 2 displaced relative to the second image frame of FIG. 2; and

FIG. 18 is a simplified block diagram of a video processor, exemplary of an embodiment of the present invention.

### DETAILED DESCRIPTION

In overview, in a method exemplary of embodiments of the present invention, motion vectors are determined from two images by obtaining one or more candidate motion vectors from the two images. Regions of the two images associated with the candidate motion vector are modified. Thereafter, further candidate motion vectors are obtained from the modified images. It has been found that modifying the two images to remove from consideration objects associated with an already obtained candidate motion vector can improve the quality of candidate motion vectors subsequently obtained from the modified images. Candidate motion vectors may thereafter be further processed and analysed to obtain motion vectors useable in video processing.

The regions may represent the same object within the images; portions of objects; image portions having a defined geometry (e.g. square or rectangular blocks); or the like.

In effect, motion vectors are determined iteratively or recursively. Once an adequate motion vector has been determined using for example phase correlation, minimum sum of absolute differences, matching methods based on object segmentation, colour similarity, and so on, regions giving rise to the motion vector not considered in subsequent correlation and assignment. This eliminates content cross-talk that inevitably occurs when regions for which motion vectors are unnecessarily reconsidered in subsequent correlation and matching.

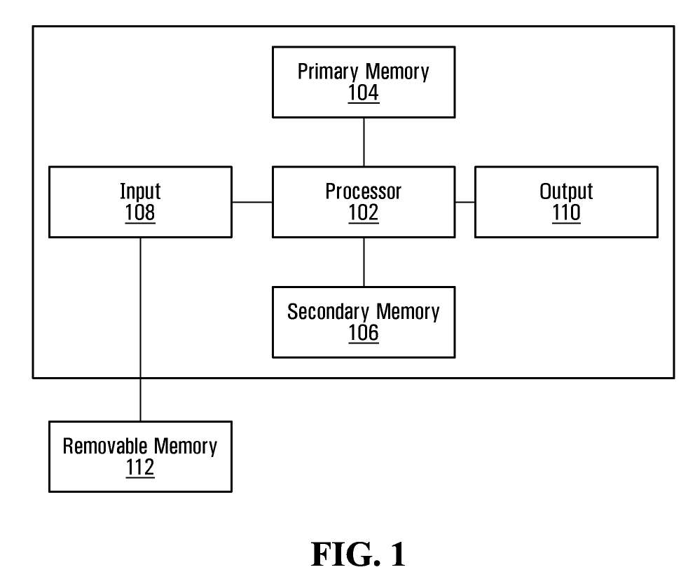

In one embodiment, the method may be performed, at least in part, by a device capable of video processing. A suitable video processing device may take the form of a video processor forming part of a set-top box, a video receiver, a television, a graphics subsystem, a computing device, or the like. In FIG. 1, a computing device 100 exemplary of embodiments of the present invention is schematically illustrated.

Computer 100 includes a processor 102, which communicates with primary memory 104, secondary memory 106, and input and output peripheral 108, 110. Computer 100 may optionally communicate with a network (not shown).

Processor 102 may be a general purpose processor, and may include one or more processing cores, for processing computer executable codes and data.

Each of memories 104 and 106 is suitable for storing electronic data including processor executable code. Primary memory 104 is readily accessible by processor 102 at runtime and may take the form of synchronous dynamic random access memory (SDRAM). Secondary memory 106 may include persistent storage memory for storing data permanently, typically in the form of electronic files. Secondary memory 106 may also be used for other purposes known to persons skilled in the art. A computer readable medium may be any available media accessible by a computer, either removable or non-removable, either volatile or non-volatile, including any magnetic storage, optical storage, or solid state storage devices, or any other medium which may embody the desired data including computer executable instructions and can be accessed, either locally or remotely, by a computer or computing device. Any combination of the above is also included in the scope of computer readable medium.

Input peripheral 108 may include one or more suitable input devices, and typically includes a keyboard and a mouse. It may also include a microphone, a scanner, a camera, and the like. It may also include a computer readable medium such as removable memory 112 and the corresponding device for accessing the medium. Input peripheral 108 may be used to receive input from the user. An input device may be locally or remotely connected to processor 102.

Output peripheral 110 may include one or more output devices, which may include a display device, such as a monitor. Suitable output devices may also include other devices such as a printer, a speaker, and the like, as well as a computer writable medium and the device for writing to the medium. Like an input device, an output device may be local or remote.

It will be understood by those of ordinary skill in the art that computer system 100 may also include other, either necessary or optional, components not shown in the figure.

Memory 104, 106 or 112 may be used to store image or computation data, calculation results, or other input and output data used in the motion vector generation process.

Memory 104, 106 or 112 may also store processor executable code, which when executed by processor 102 causes computer 100 to carry out any of the methods described herein. For example, the processor executable code may include code for obtaining at least one candidate motion vector from a first image and a second image; code for determining a first region in said first image and a second region in said second image; code for modifying said first and second images; and code for obtaining and storing a candidate motion vector from said modified first and second images, as will be further described below.

As can be appreciated, methods described herein may also be carried out in whole or in part using a hardware device having circuits for performing one or more of the described calculations or functions. For example, the functions of one or more of the above mentioned program code may be performed by a graphics processor, a component thereof, or one or more application specific integrated circuits (ASICs).

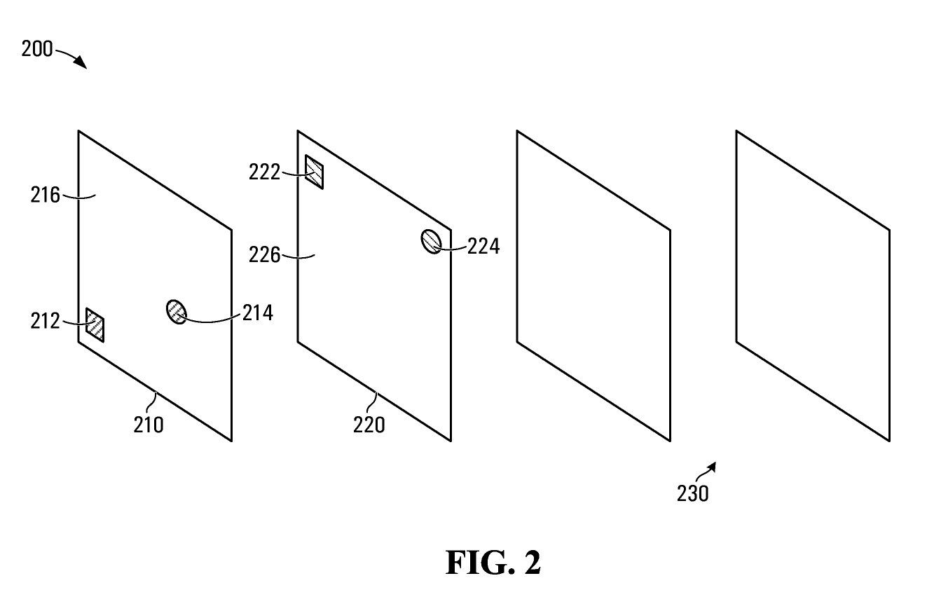

Motion vectors can be determined using embodiments of the present invention from any two images. For the purposes of illustration, it is assumed that motion vectors are to be determined from an image frame 210 and an image frame 220 in a video sequence 200 as shown in FIG. 2. Methods can also be applied to image frames 230 subsequent to image frame 220 in video sequence 200. For purposes of illustration, in first image frame 210, white background 216 defines a black square object 212 and a black circular object 214. In second image frame 220, white background 226 also defines a black square object 222 and a black circular object 224.

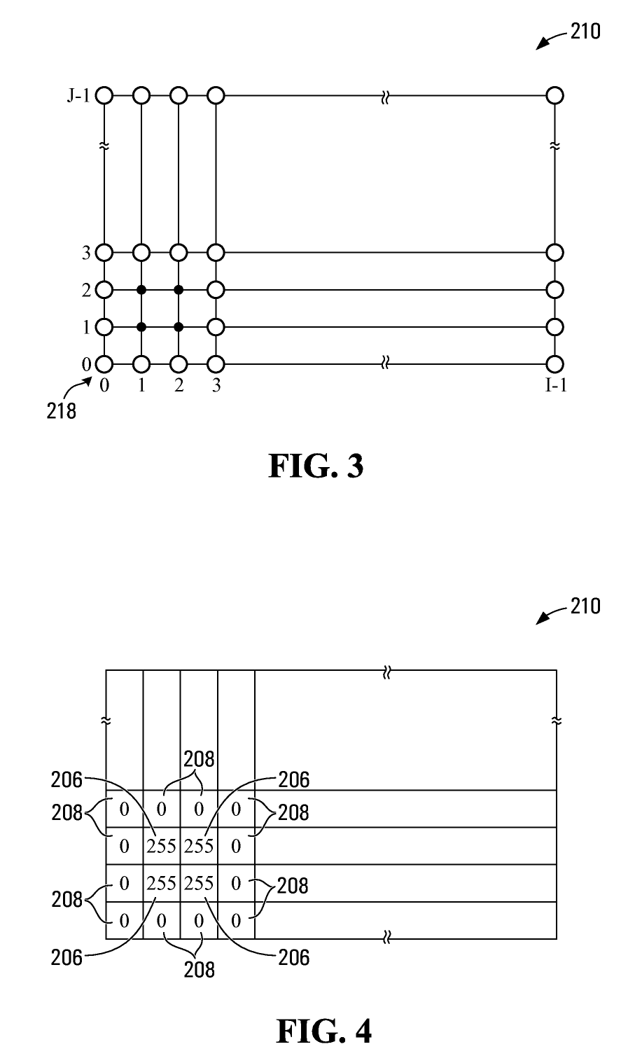

Typically, an image is represented as a grid of pixels referenced by a two-dimensional coordinate system. For illustration, it is assumed that the origin is a corner of the image and the first and second axes extend outwards from the origin along the edges of the image. This exemplary coordinate system is illustrated in FIG. 3 where the origin is corner 218 of image frame 210, the X axis extends outwards from the origin along the horizontally depicted edge of image frame 210, and the Y axis extends outwards from the origin along the vertically depicted edge of image frame 210.

In this exemplary coordinate system, the coordinates of individual pixels 202 are represented in the form [a,b] where the first coordinate, a, is in reference to the X axis and the second coordinate, b, is in reference to the Y axis. For an exemplary image p, individual pixels of the image are referenced with the notation p[a,b]. Assuming this exemplary coordinate system, image frames 210 and 220 are rectangular, of size I×J.

FIG. 4 is a schematic diagram of image frame 210 showing the intensity values of individual pixels 206 and 208 of a portion of image frame 210. In the example embodiment, intensity values of individual pixels of image frames 210 and 220 are represented using 8 bits, and thus range from 0 to 255. Black pixels 206 have the intensity value of 255. As will be appreciated, intensity values could easily be represented by more or fewer than 8 bits per pixel. Similarly, colour (chroma) values in addition to, or in place of intensity values, of pixels could be used to determine motion vectors and associated pixel regions as described herein.

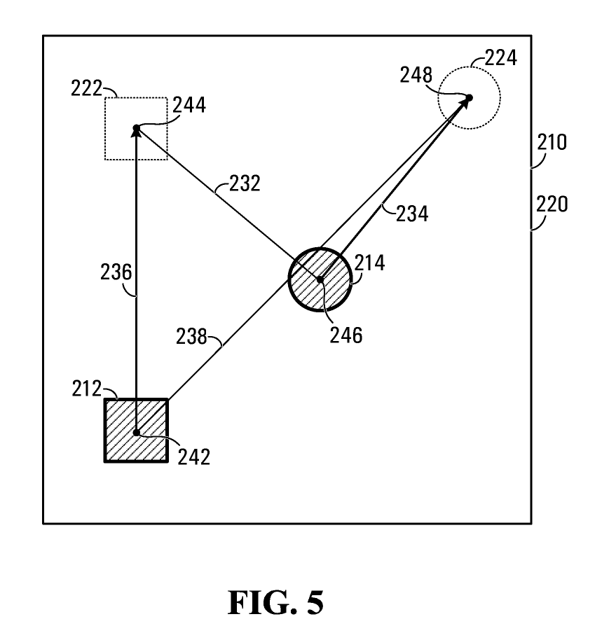

The superposition of image frame 210 over image frame 220 is shown in FIG. 5. Image frames 210 and 220 use the same co-ordinate system, so that the outer edges of image frames 210 and 220 coincide. Vector 236 describes the change in position of black square objects 212 and 222 between image frame 210 and image frame 220. Vector MV₁=[x₁, y₁] 236 has a starting position 242 corresponding to the coordinates of the center of black square object 212 in image frame 210 and an ending position 244 corresponding to the coordinates of the center of the black square object 222 in image frame 220. A similar vector MV₂=[x₂, y₂] 234, starting at position 246 and ending at position 248, describes the change in position of black circular regions 214 and 224 between images frames 210 and 220. Regarding the changes in position of black objects 212, 222, 214, and 224 as motion, vectors 236 and 234 are true motion vectors as they describe the motion of black objects 212, 222, 214, and 224 between image frame 210 and image frame 220. Vectors MV₃=[X₃, y₃] 232 and MV₄=[X₄, y₄] 238 similarly are false motion vectors as they do not describe the motion of black objects 212, 222, 214, and 224 between image frames 210 and 220. In this exemplary description, a list of motion candidate motion vectors that includes motion vectors 236 and 234 is determined.

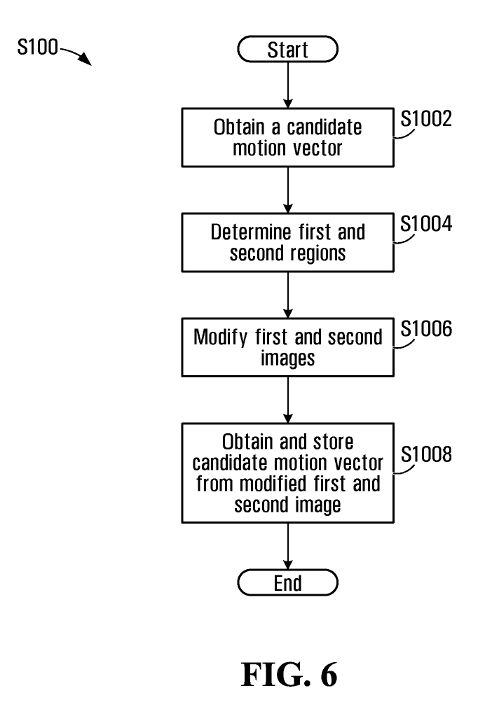

Motion vectors can be determined from image frames 210 and 220 according to blocks S100 illustrated in FIG. 6, exemplary of embodiments of the present invention. For ease of explanation, blocks S100 will be illustrated with reference to sequential image frames 210 and 220 of video sequence 200.

At S1002, candidate motion vectors are obtained from image frames 210 and 220 in a conventional manner. For example, motion vector MV₁ 236 can be determined from image frames 210 and 220 [HOW?], using block matching techniques, by inspecting image frames 210 and 220 to identify black square objects 212 and 222 as corresponding objects, then determining the vector that describes the change in position of black square objects 212 and 222, or otherwise. Typically, multiple candidate motion vector can be obtained from two images.

At S1004, a first region in image frame 210 and a second region in image frame 220 are determined to be associated with an obtained candidate motion vector. Both the first region in image frame 210 and the second region in image frame 220 may consist of one or more discontinuous regions of image frames 210 and 220 respectively. Assuming the obtained candidate motion vector is motion vector MV₁ 236, in one embodiment, image frames 210 and 220 may be compared to block match corresponding pairs of objects or blocks that appear in both image frame 210 and image frame 220. For each pair of corresponding objects, if motion vector MV₁ 236 correctly describes the change in position of the objects between image frames 210 and 220, then the regions of image frames 210 and 220 corresponding to the pair of objects are considered to be part of the first and second regions respectively. Analysis of image frames 210 and 220 should identify black square objects 212 and 222 as forming one pair of corresponding objects, and black circular objects 214 and 224 as forming a second pair of corresponding objects. As motion vector MV₁ correctly describes the change in position of black square objects 212 and 222 and does not correctly describe the change in position of black circular objects 214 and 224, the first region in image frame 210 is determined to be equivalent to region 212 and the second region in image frame 220 is determined to be equivalent to region 222. In embodiments of the present invention where more than one candidate motion vector is obtained at S1002, regions of image frames 210 and 220 are associated with one or more obtained candidate motion vector for the region to be considered part of the first and second regions determined at S1004.

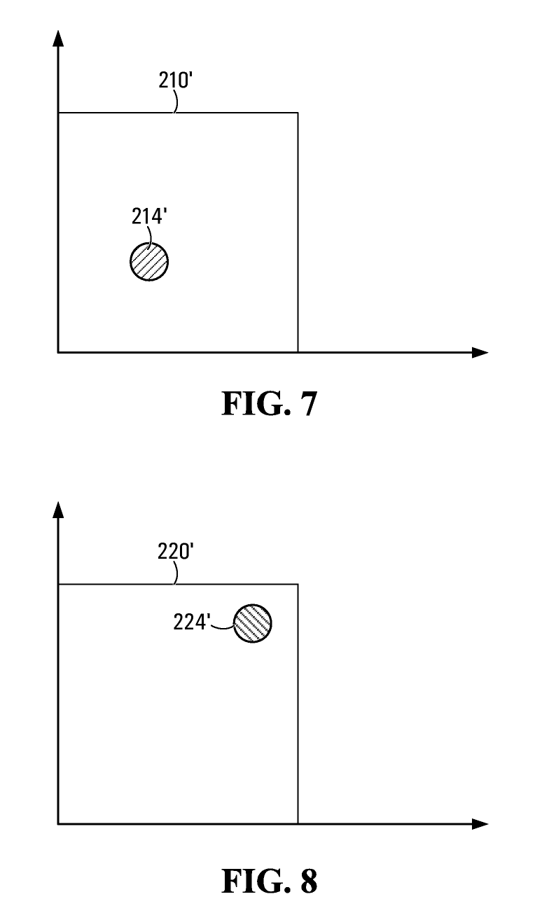

At S1006, the first and second region in image frames 210 and 220 are modified by setting the intensity values of the pixels in both regions to a default intensity value. In one embodiment, the default intensity value is zero. FIGS. 7 and 8 illustrate modified image frames 210′ and 220′ where the above determined first and second regions in image frames 210 and 220 are modified by setting the intensity values of the pixels in the first and second regions to zero. As black circular objects 214 and 224 were not previously determined to be associated with candidate motion vector MV₁ 236, black circular objects 214′ and 224′ appear in modified image frames 210′ and 220′. As black square objects 212 and 222 were previously determined to be associated with candidate motion vector MV₁ 236, corresponding black square objects do not appear in 210′ and 220′.

At S1008, an additional candidate motion vector is obtained from modified image frames 210′ and 220′. As at S1002, candidate motion vectors may be determined in a conventional manner—e.g. by block matching. Conveniently, pixels with default intensity values may be ignored in such a determination. Modified image frames 210′ and 220′ are analyzed to identify corresponding objects with pixels at non-default intensity values from which the vector describing the change in position of the objects from image frame 210′ to image frame 220′ can be considered a candidate motion vector. As such, the additional candidate motion vector obtained from modified image frames 210′ and 220′ is more likely to be a true motion vector in comparison to an additional candidate motion vector obtained from unmodified image frames 210 and 220.

For purposes of illustration, as the pixels forming black square objects 212 and 222 have been set to default intensity values indicating that these pixels are to be ignored, visual inspection of modified image frames 210′ and 220′ may determine true motion vector MV₂ 234 as a candidate motion vector, whereas visual inspection of unmodified image frames 210 and 220 may result in the determination of false motion vectors MV₃ 232 or MV₄ 238 as a candidate motion vector. In other embodiments of the present invention, more than one candidate motion vector can be obtained from modified image frames 210′ and 220′.

The one or more candidate motion vectors obtained from modified image frames 210′ and 220′ are stored, together with the one or more candidate motion vectors obtained from unmodified image frames 210 and 220, as candidate motion vectors for image frames 210 and 220. These candidate motion vectors can be stored in computer memory 104, 106, or 112 for further processing.

In some embodiments, a candidate motion vector may be obtained through calculating a correlation of image frames 210 and 220 where image frame 210 has been displaced relative to image frame 220. If the calculated correlation satisfies a selected condition, the displacement of image frame 210 relative to image frame 220 is determined to be a candidate motion vector.

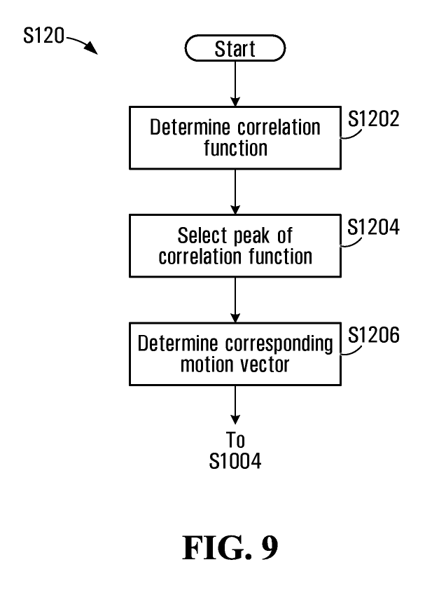

FIG. 9 illustrates an exemplary blocks S120 to obtain a candidate motion vector from image frames 210 and 220, employed at S1002 of blocks s100.

At S1202, a correlation function may first be determined from image frames 210 and 220. The dependent variable of a correlation function is the correlation of image frames 210 and 220 where image frames 210 and 220 are displaced relative to one another by independent variables specifying the relative displacement of image frames 210 and 220. The correlation function may be described in the form f(x,y) where the independent variable x specifies the relative displacement of image frames 210 and 220 in the X axis and the independent variable y specifies the relative displacement of image frames 210 and 220 in the Y axis. As image frames 210 and 220 are both I×J in size, f(x,y) is defined over the domain −I<x<I, −J<y<J.

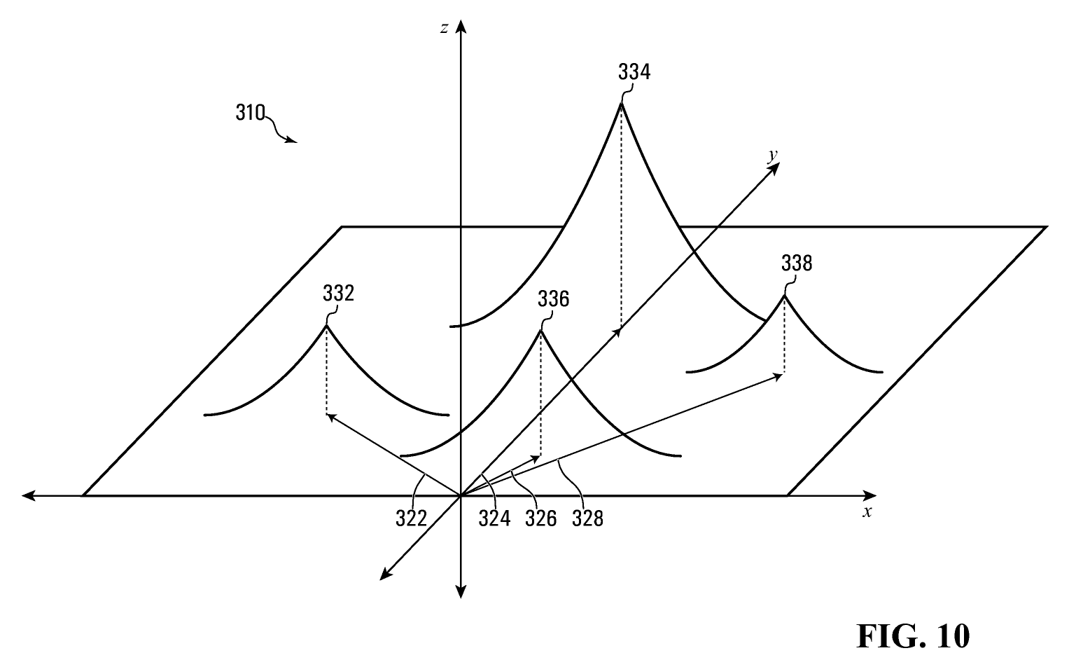

Correlation function f(x,y) can be visualized as correlation surface 310 as depicted in FIG. 10. Correlation surface 310 is represented in a coordinate system where the X and Y axes respectively indicate the displacement of image frame 210 relative to image frame 220 along the X and Y axes as defined for an image, and the Z axis of the coordinate system indicates the degree of correlation between relatively displaced image frames 210 and 220. As a correlation surface is merely a visualization of a correlation function, the terms correlation surface and correlation function may be used interchangeably.

At S1204 and S1206, a point on correlation surface 310 satisfying a condition may be used to determine a corresponding vector that may be treated as a candidate motion vector. The corresponding vector is typically defined as the vector originating at the origin and ending at the projection of the selected point onto the X-Y plane. Using the previously described convention for representing a vector, an arbitrary point (x,y,f(x,y)) on correlation surface 310 typically corresponds to candidate motion vector [x,y]. A variety of conditions may be employed in order to select an appropriate point of correlation surface 310 from which to determine a candidate motion vector.

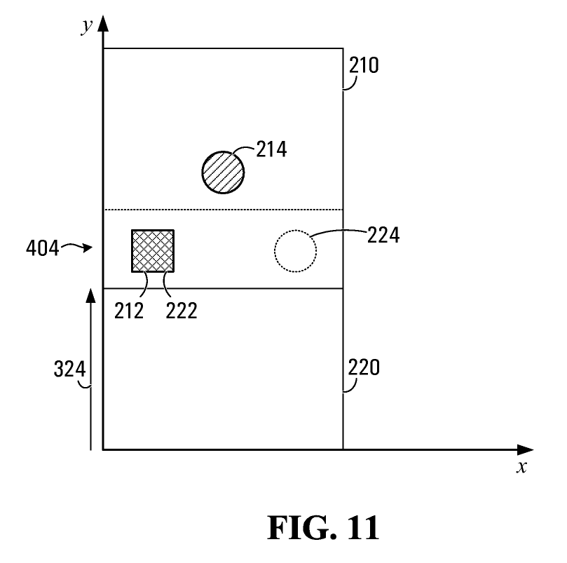

Exemplary points on correlation surface 310 of relatively high correlation 332, 334, 336, and 338 are considered peaks of correlation surface 310. Point 334 is generated by displacing image frame 210 relative to image frame 220 by vector 324 originating at the origin and ending at the projection of point 334 onto the X-Y plane. FIG. 11 exemplifies the displacement of image frame 210 relative to image frame 220 by vector 324. The Z-coordinate of point 334 is calculated as the correlation of overlapped region 404. Points 336, 332, and 338 are similarly generated by displacing image frame 210 relative to image frame 220 by vectors 326, 322, and 328 respectively and calculating the correlation of overlapped regions.

At S1204 and S1206, in one embodiment, a peak of correlation surface 310 is identified and used to determine a corresponding vector thereafter considered a candidate motion vector. Conventional techniques to identify local maxima of functions can be utilized to identify a peak of correlation surface 310. In another embodiment, maximum peak 334 of correlation surface 310 is identified and used to determine candidate motion vector 324. In other embodiments of the present invention, multiple peaks of correlation surface 310 can be identified and used to determine multiple candidate motion vector.

In another embodiment of the present invention, the correlation function determined from image frames 210 and 220 at S1202 is a phase correlation, also known as a phase plane correlation surface. The use of a phase correlation can be advantageous in comparison to a different correlation function such as a cross-correlation as the phase correlation normalizes the correlation with respect to the luminance of pixels. A phase correlation is defined below for two images A and B of size I×J following the previously described convention for referring to the individual pixels of images.

$$phase correlation ( A , B ) = {}^{- 1} ( h ) , where$$

$$h [ x , y ] = \frac{ℵ ( ( ( A ) ) [ x , y ] ) ( ( B ) ) [ x , y ]}{\vert ℵ ( ( ( A ) ) [ x , y ] ) \vert \vert ( ( B ) ) [ x , y ] \vert}$$

$$( f ) = discrete fourier transform of f$$

$${}^{- 1} ( f ) = inverse discrete fourier transform of f$$

$$ℵ ( x ) = complex conjugate of x$$

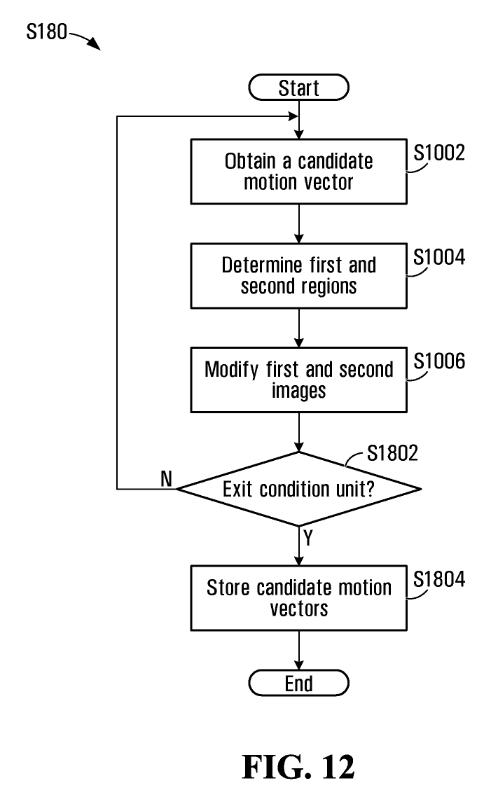

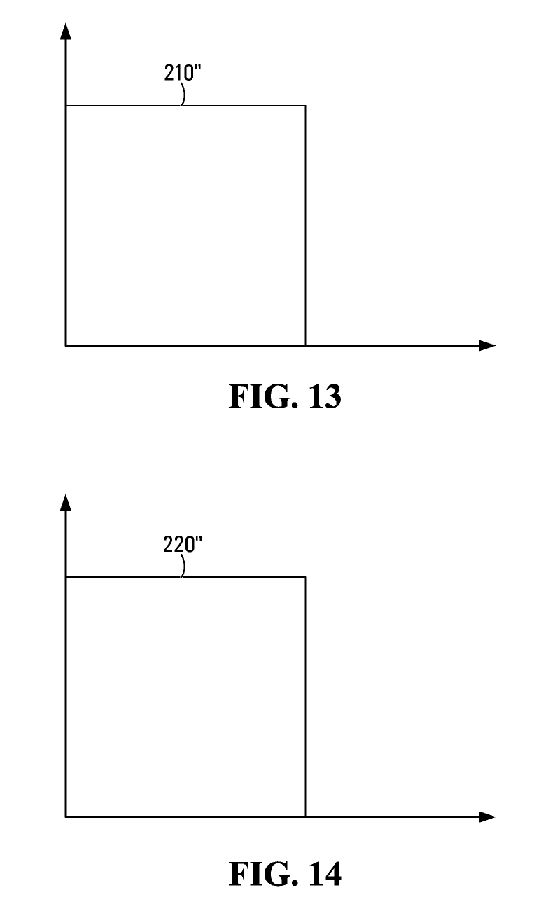

FIG. 12 illustrates one embodiment whereby obtaining and storing a candidate motion vector from exemplary modified image frames 210′ and 220′ entails repeating the previously described process. At S1002, candidate motion vector MV₁ 236 is obtained from image frames 210 and 220. At S1004, first and second regions of image frames 210 and 220 are determined to be associated with candidate motion vector MV₁ 236. At S1006, determined first and second regions of image frames 210 and 220 are modified, forming modified image frames 210′ and 220′. At S1802, an exit condition is tested to determine whether a desired number of motion vectors have been obtained, or if additional candidate motion vectors should be extracted from modified image frames 210′ and 220′. If the exit condition is met, obtained candidate motion vectors, so far candidate motion vector MV₁ 236, are stored at S1804 as candidate motion vectors for image frames 210 and 220. If the exit condition is not met, the process is repeated for modified image frames 210′ and 220′. At S1002, candidate motion vector MV₂ 234 is obtained from modified image frames 210′ and 220′. At S1004, first and second regions of modified image frames 210′ and 220′ are determined to be associated with candidate motion vector MV₂ 234. The first region of modified image frame 210′ is the region defined by black circular object 214′. The second region of modified image frame 220′ is the region defined by black circular object 224′. At S1006, determined first and second regions of modified image frames 210′ and 220′ are modified, forming further modified image frames 210″ and 220″ as depicted in FIG. 13. At S1802, the exit condition is again tested to determine whether additional candidate motion vectors should be extracted from twice modified image frames 210″ and 220″. Assuming the exit condition is met, candidate motion vectors MV₁ 236 and MV₂ 234 are stored at S1804 as candidate motion vectors for image frames 210 and 220.

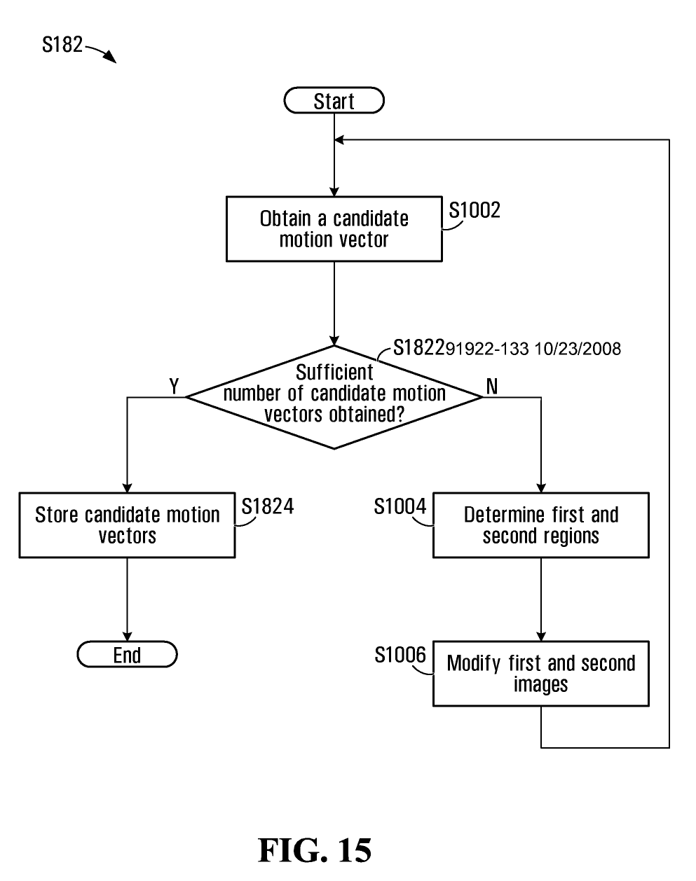

There are a variety of suitable exit conditions that may be utilized. In one embodiment, the exit condition may constitute examining the modified images to determine whether at least one of the modified images has been modified so that the proportion of the modified image that has the default intensity value is greater than a selected threshold. FIG. 15 illustrates another embodiment of the present invention where the exit condition constitutes determining whether a sufficient number of candidate motion vectors have been already obtained. In this embodiment, exit condition S1822 is tested prior to S1004 as additional modification is unnecessary if the exit condition is already met. If the exit condition is met, the obtained candidate motion vectors are stored at S1824. If the exit condition is not met, first and second regions are determined at S1004, the images are modified at S1006, and a candidate motion vector is obtained from modified images at S1002 prior to the exit condition again being considered at S1822.

It is worth noting that an exit condition does not necessarily require all of the pixels of the images to be assigned a motion vector. Often when there is relative motion between two images there are occlusions and uncoverings. These regions represent content that has become hidden and content that is new. Such content has no correspondence and usually requires separate treatment.

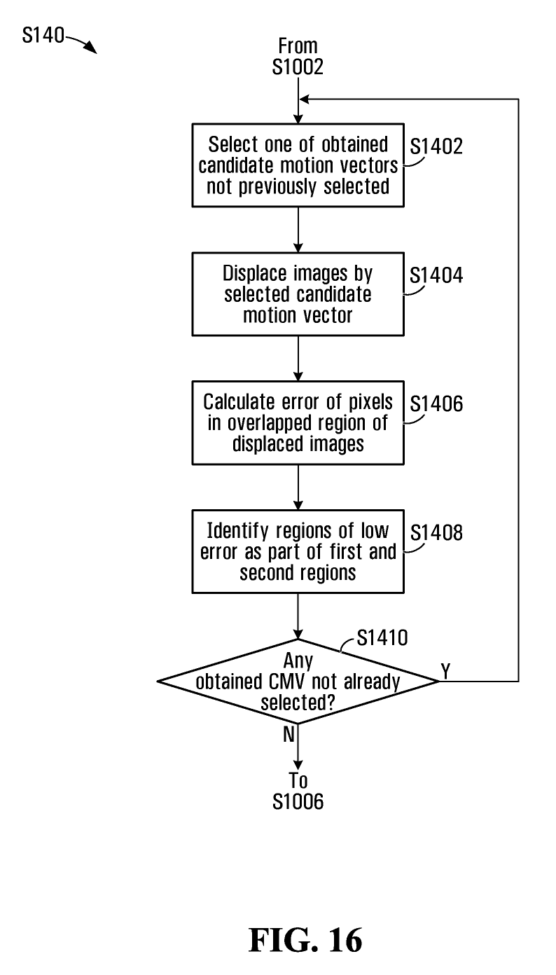

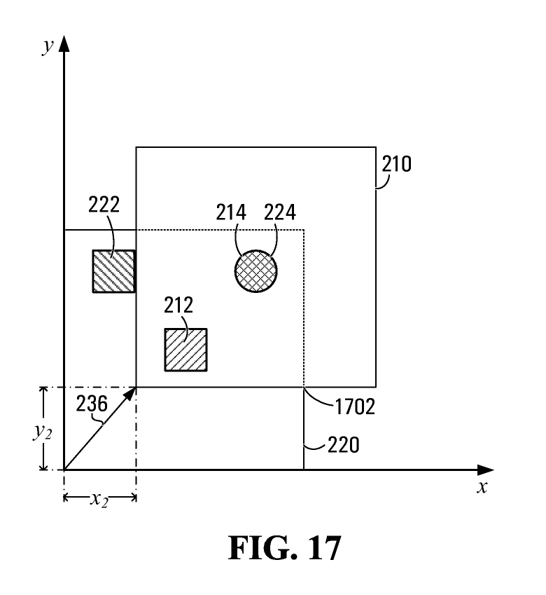

Once a candidate motion vector has been determined, first and second regions associated with that candidate motion vector may be determined as illustrated in FIG. 16. Illustrating process S140 with exemplary image frames 210 and 220, it is assumed that candidate motion vector MV₂=[x₂,y₂] 236 has been obtained from S1002. At S1404, image frame 210 is displaced by x₂ in the X axis and Y₂ in the Y axis relative to image frame 220 as illustrated in FIG. 17.

At S1406, an error value is calculated for groups of pixels in overlapped region 1702. Grouping of pixels may be done in any conventional manner. For example, adjacent pixels forming rectangles or squares may be grouped. Alternatively, pixels within detected object edges may be group. The error value calculated can be the sum of absolute differences in intensity value between a group of pixels in frame 210 as displaced by MV₂, and that group of pixels in frame 220. Of course, error calculation could be filtered—anistropic, bilaterally, or otherwise so that the calculated error value for a group of pixels is a function of the position and intensity values of a region surrounding the group of pixels.

At S1408, a first region in image frame 210 as displaced and a corresponding second region in image frame 220 are compared to determine if a calculated error comparison satisfies a selected condition. If so, the first region is determined to be pixels in image frame 210 that are part of the group of pixels satisfying the selected condition. Similarly, the second region is determined to be pixels in image frame 220 that are part of a pair of pixels satisfying the selected condition. In one embodiment of the present invention, groups of pixels in frame 220 corresponding to a minimum error to a group of corresponding pixels in frame 210 (less than a selected threshold) may be treated as first and second group of pixels associated with the candidate motion vector MV₁ 236. Other conditions that may be employed include testing for whether the average calculated error of a block of pixels is less than a selected threshold, or some other function of the error values of a region of pixels.

For example, assuming the error value calculated is the absolute difference in intensity values and the condition that needs to be satisfied is that the error value is near zero, at S1406, the coincident groups of pixels in overlapped region 1702 have an error value near. Thus, the first region in image frame 210 associated with candidate motion vector MV₁ 236 may be the region of image frame 210 in overlapped region 1702 except for the pixels representing black square object 212. Similarly, the second region in image frame 220 associated with candidate motion vector MV₁ 236 is the region of image frame 220 in overlapped region 1702 except for the pixels coincident with pixels representing black square object 212.

At S1410, process S140 may be repeated for each obtained candidate motion vector from S1002.

Now, the regions determined to be associated with each obtained candidate motion vector in each frame 210, 220 may be modified by setting pixel intensities in frames 210, 220 to a default intensity. Once regions have been modified, additional candidate motion vectors may be determined, by for example, repeating blocks S100 or S120.

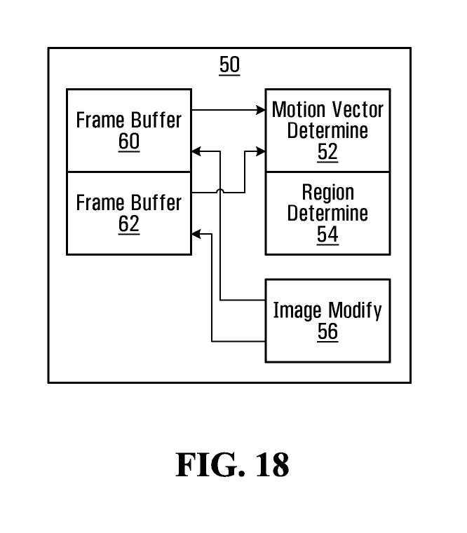

As will now be appreciated, the above described techniques may be implemented exclusively or partially in hardware. To this end, as illustrated in FIG. 18, a video processor 50 may be formed to include several functional blocks 52, 54 and 56 including a first functional block 52 for obtaining at least one candidate motion vector representing motion of a region from a first image to a second image; a second functional block 54 for determining the region in the first image and the second image associated with the at least one candidate motion vector; and a third functional block 56 for modifying the first and second images by setting pixel intensities in the region in the first and second images to a default intensity. The first, second and third logic functional blocks repeat the obtaining, determining, and modifying, using the first and second images as modified by the third functional block, until a desired number of motion vectors have been determined for said first and second images.

As will be appreciated, each of the functional blocks may be formed using suitable combinatorial or sequential hardware logic. Alternatively, the functional blocks may be formed using a combination of software logic and/or hardware logic. Video processor 50 may include one or more frame buffers 60, 62 to store the images for which candidate vectors are to be determined, or it may operate on external frame buffers (not illustrated). Each of the functional blocks may be formed to operate as described above—e.g. to calculate phase correlation, or the like. Video processor 50 may further be under software or firmware control.

As will now be appreciated, initial pre-processing of the two images can be performed. Although the two images have been herein assumed to be rectangular and identical in size in both the X and Y axes, dissimilar images can be initially modified by appending a default value to ensure they are of identical size. Similarly, colour images can modified by conventional techniques to become grayscale images.

In other embodiments of the present invention, the correlation function may be interpolated to achieve sub-pixel resolution for the obtaining of corresponding candidate motion vectors.

The modification of the first and second images can vary in accordance with the technique employed to obtain candidate motion vectors from the modified first and second images. In previously described embodiments of the present invention, the intensity value of pixels in the first and second regions are set to zero. Conveniently, the phase correlation function can be constructed so as to ignore pixels with an intensity value of zero. In other embodiments of the invention, the intensity values may be modified to other default values to effect similar consequences.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of determining motion vectors for images, comprising:
(a) determining a first region in a first image and a second region in a second image associated with a candidate motion vector;
(b) modifying said first and second images by setting pixel intensities in said first and second regions in said first and second images to a default intensity; and
(c) obtaining and storing a candidate motion vector from said first and second images as modified in (b), as a motion vector for said first and second images.

2. The method of claim 1, wherein obtaining a candidate motion vector from two images comprises:
calculating a correlation between said two images as a function of displacement of one of said two images relative to the other of said two images; and
when said correlation satisfies a selected condition, selecting a motion vector representing said displacement as said candidate motion vector from said two images.

3. The method of claim 2, wherein said selected condition is satisfied when said correlation is a local maximum or local minimum.

4. The method of claim 3, wherein said selected condition is satisfied when said correlation is the maximum.

5. The method of claim 2 wherein said correlation function is a phase correlation function.

6. The method of claim 1 comprising repeating (a) to (c) for modified first and second images.

7. The method of claim 6, wherein (a) to (c) are repeated.

8. The method of claims 1, wherein said default intensity has an intensity value of zero.

9. The method of claim 1, wherein said obtaining at least one candidate motion vector comprises searching said first image and said second image for matching regions.

10. A computer comprising a processor and a computer readable memory, adapted to perform the method of claim 1.

11. A computer readable medium storing thereon computer executable code, said code when executed by a computer adapts said computer to perform the method of claim 1.

12. A method of determining motion vectors for first and second images, comprising:
(a) obtaining at least one candidate motion vector representing motion of a region from said first image to said second image;
(b) determining said region in said first image and said second image associated with said at least one candidate motion vector;
(c) modifying said first and second images by setting pixel intensities in said region in said first and second images to a default intensity; and
(d) repeating said obtaining, determining, and modifying, using said first and second images as modified in (c), until a desired number of motion vectors have been determined for said first and second images.

13. The method of claim 12, wherein said obtaining comprises determining a phase correlation between said first image and said second image.

14. The method of claim 13, wherein said determining comprises determining a local maxima of said phase correlation.

15. A video processor comprising:
a first logic block for obtaining at least one candidate motion vector representing motion of a region from said first image to said second image;
a second logic block for determining said region in said first image and said second image associated with said at least one candidate motion vector;
a third logic block for modifying said first and second images by setting pixel intensities in said region in said first and second images to a default intensity; and
wherein said first, second and third logic blocks repeat said obtaining, determining, and modifying, using said first and second images as modified by said third logic block, until a desired number of motion vectors have been determined for said first and second images.

16. The video processor of claim 15, wherein said first logic block determines a phase correlation for said first and second images.

17. The video processor of claim 16, wherein said first logic block determines a maximum of said phase correlation for said first and second images.
